(19) United States
(12) Patent Application Publication
(10) Pub. No.: US 2005/0199240 A1
(43) Pub. Date: Sep. 15, 2005

(54) Flexible full-face mask for CPAP treatment

(76) Inventor: Matthew Hall, Roswell, NM (US)

Correspondence Address: ROBERTS ABOKHAIR & MARDULA, SUITE 1000, 11800 SUNRISE VALLEY DRIVE, RESTON, VA, 20191, US

(21) Appl. No.: 10/755,029

(22) Filed: Jan. 9, 2004

Related U.S. Application Data
(60) Provisional application No. 60/439,073, filed on Jan. 9, 2003.

(51) Int. Cl. A62B 18/08

(52) U.S. Cl. 128/206.26

(57) ABSTRACT

A Continuous Positive Air Pressure (CPAP) full-face mask employs a flexible shell to allow a single device to comfortably fit a wide variety of users. It preferably employs a positionable guide wire at a periphery of the shell to allow the periphery of the flexible shell to be deformed to conform to the shape of a users face. It additionally uses a simpler design to allow lower cost and improved ease of use.

### RELATED APPLICATIONS

This application claims priority to U.S. Provisional Application Ser. No. 60/439,073, filed Jan. 9, 2003.

### BACKGROUND OF THE INVENTION

CPAP (Continuous Positive Airway Pressure) is used to treat Obstructive Sleep Apnea (OSA) by delivering a fixed pressure of normal room air. This air pressure supports the airway by acting like an artificial splint, thereby preventing the airway from collapsing during sleep. CPAP is considered the most successful, non-invasive way of treating OSA and other sleep related breathing disorders.

The most common type of mask used for CPAP treatment is a nasal mask that covers only the nose of the patient. This type of mask is popular because of its small size and its ability to fit a large variety of faces. However, it is not effective if the user breathes through their mouth, so numerous gadgets have been employed to assure the user's mouth is closed, such as chinstraps and lip clamps. A more optimum solution is a full-face mask that covers both the nose and mouth.

CPAP full-face masks are less common than nasal masks and typically consist of a clear, rigid shell dimensioned to cover the nose and mouth and a flexible, cushioned seal for contacting the users face. To properly fit the user, seals are usually provided in a variety of sizes and can often involve the expense of purchasing and trying-out of multiple seals prior to finding a sufficiently comfortable and effective seal. Other problems encountered with prior art CPAP full-face masks, like the Mirage® Full-face Mask Series 1 & 2 from ResMed® and the Spectrum® Reusable Full-face Mask from Respironics® include breakage of the rigid shell, difficult servicing and cleaning due to the large number of small parts (most of which are clear and can easily be lost), high cost, difficult manipulation of head straps for consistent fit, difficult manipulation of port covers by the elderly, sores caused when users roll and put pressure on the rigid shell (that, in turn, presses against the face), unintended disassembly of the elbow when users manipulate the mask by grasping the release prongs of the elbow, and poor location of exhalation ports that tend to bother a user's bedmate due to outwardly directed air flow (preventing “spooning”), further altering a user's lifestyle.

Indeed, the high cost and complication of prior art CPAP full-face masks make them undesirable, unaffordable and/or unusable to many people who could benefit from CPAP treatment.

The present invention is drawn to a CPAP full-face mask that employs a flexible shell to allow a single device to comfortably fit a wide variety of users. It preferably employs a positionable guide wire at a periphery of the shell to allow the periphery of the flexible shell to be deformed to conform to the shape of a users face. It additionally uses a simpler design to allow lower cost and improved ease of use, as further discussed below.

### BRIEF SUMMARY OF THE INVENTION

The present invention provides a CPAP full-face mask with a flexible shell and positionable guide wire to allow a single size of mask to comfortably fit a wide variety of users.

It is an object of the invention to provide a CPAP full-face mask that eliminates the hard plastic frame that can dig into a user's face.

It is another object of the invention to provide a CPAP full-face mask that eliminates the need for multiple seal sizes.

It is a further object of the invention to provide a CPAP full-face mask that includes an integrated, two-layer seal to eliminate the complication of seal installation and replacement.

It is an object of the invention to provide a CPAP full-face mask that is inexpensive enough and durable enough to be replaced annually.

It is yet another object of the invention to provide a CPAP full-face mask having a reduced number of parts.

It is an object of the invention to provide a CPAP full-face mask having components formed of latex-free material.

It is a further object of the invention to provide a CPAP full-face mask having components formed of opaque or colored material to assist in locating misplaced components.

It is an object of the invention to provide a CPAP full-face mask having easily manipulated components for the elderly and disabled.

It is another object of the invention to provide a CPAP full-face mask having a less-complicated, more reliable elbow design.

It is yet a further object of the invention to provide a CPAP full-face mask having a less obtrusive exhalation port.

It is an object of the invention to provide a CPAP full-face mask having a comfortable seal.

It is another object of the invention to provide a CPAP full-face mask having an easy to use and stable five-point harness.

### BRIEF DESCRIPTION OF THE DRAWINGS

FIG. 1 illustrates a perspective view of one embodiment of the present invention.

FIG. 2 illustrates a side view of one embodiment of the present invention.

FIG. 3 illustrates a front view of the CPAP mask according to one embodiment of the present invention;

FIG. 4 illustrates a back view of the flexible CPAP full-face mask according to one embodiment of the present invention;

FIG. 5 illustrates an exploded view of the elbow attachment assembly according to one embodiment of the present invention;

### DETAILED DESCRIPTION OF THE INVENTION

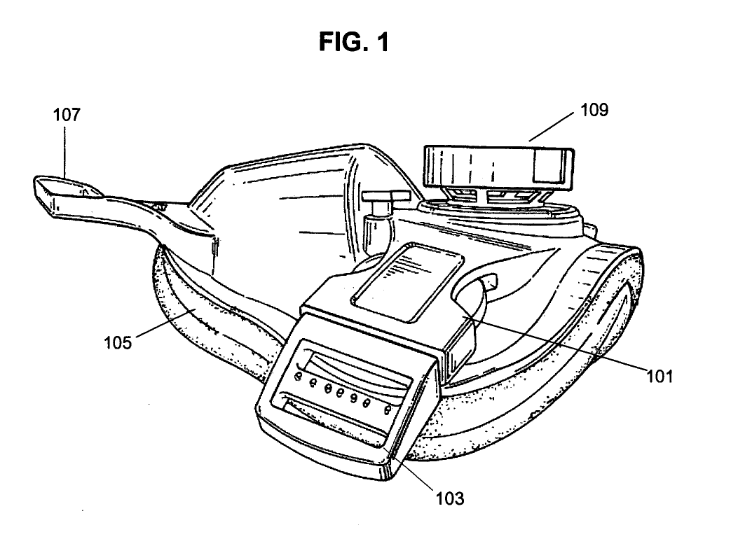

Referring now to FIG. 1, a perspective view of one embodiment of the present invention is illustrated. In a preferred embodiment of the present invention, the flexible shell of the CPAP full-face mask is fabricated from flexible, latex-free material such as polyurethane formed in a conventional manner. The result is a flexible shell that is soft and smooth to the touch, unlike the hard shells of the prior art. The flexibility of the shell allows both greater comfort due to a better, customized fit and increased durability due to its ability to bend to resist breakage while forming a air pressure seal. The custom fit and durability ensure long-term leak-free use. A strap buckle 101 allows a user to easily attach head gear (not shown) or retaining straps for attaching to a mask of the present invention. Head gear or retaining straps are attached to the strap buckle 101 via attachments 103. Additional head gear attachment points attach at the forehead strap attachment points 107. A cushion 105 is attached to the mask and lays against the users face. A contour wire (not shown) which is also referred to herein as guide wire, is positioned at the inner edge of the mask and helps shape the mask to contour to multiple facial sizes and shapes, and accommodate facial hair. A swivel assembly 109 removable attaches to the mask.

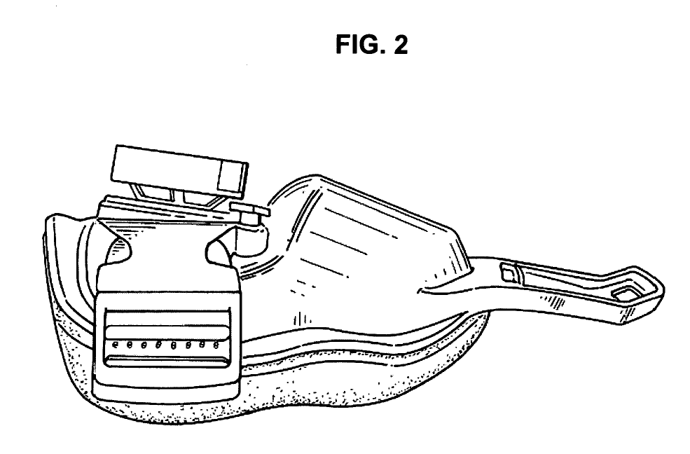

Referring now to FIG. 2, a side view of the mask is illustrated.

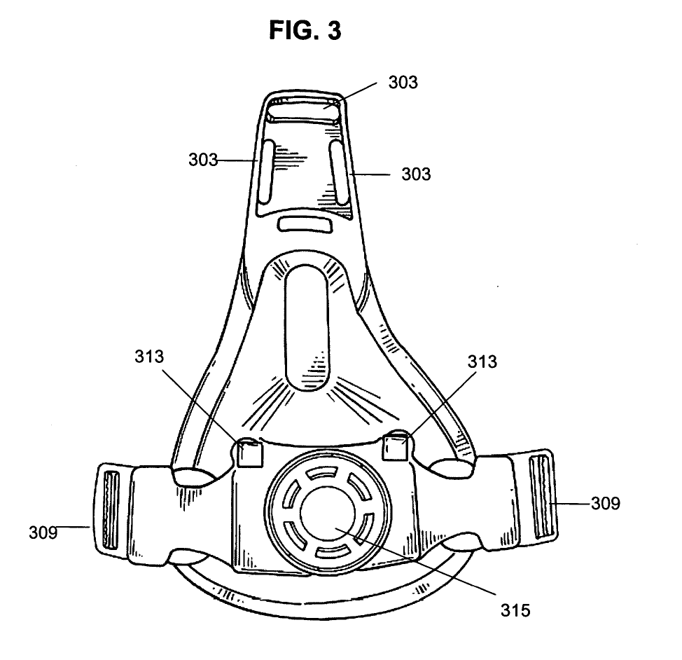

Referring now to FIG. 3, a continuous positive air pressure (CPAP) mask is illustrated according to one embodiment of the present invention. To provide a secure fit on the user, the CPAP full-face mask of the present invention preferably uses a five-point harness comprising three forehead attachments 303, and two lower, side attachments 309. According to one embodiment of the present invention, the CPAP mask is molded of polyurethane. The polyurethane construction allows a bit of stretch to these attachment points, thereby adding comfort and flexibility to the user of the mask. To ease installation and removal, the lower attachments 309, preferably employ an inexpensive and standard (i.e., easily replaced) quick-release clip that has large detents, to again ease manipulation by those with arthritic hands or disabilities. By eliminating the use of hook-and-loop harnesses, the present invention insures a correct fit.

Port covers 313 cover openings for tubes that carry oxygen or other gas to the user. The port covers 313 are shaped to have corners (i.e., square) to ease manipulation by those with arthritic hands or disabilities such as syndactyly, who can often have problems with the prior art circular-shaped port covers. The flexible shell of the CPAP mask and its associated components (other than the integrated seal) are formed of opaque and/or colored material to make the parts easier to locate.

A port 315 for attaching a rigid elbow (not shown) that delivers the positive airway pressure to the user is illustrated. The attachment of the elbow to a port 315 in the flexible CPAP mask provides that the flexible CPAP mask will absorb forward or lateral force applied to the elbow without causing displacement of the flexible CPAP mask to the same degree that occurs when the same degree of forward or lateral force is applied to an elbow attached to a rigid CPAP mask.

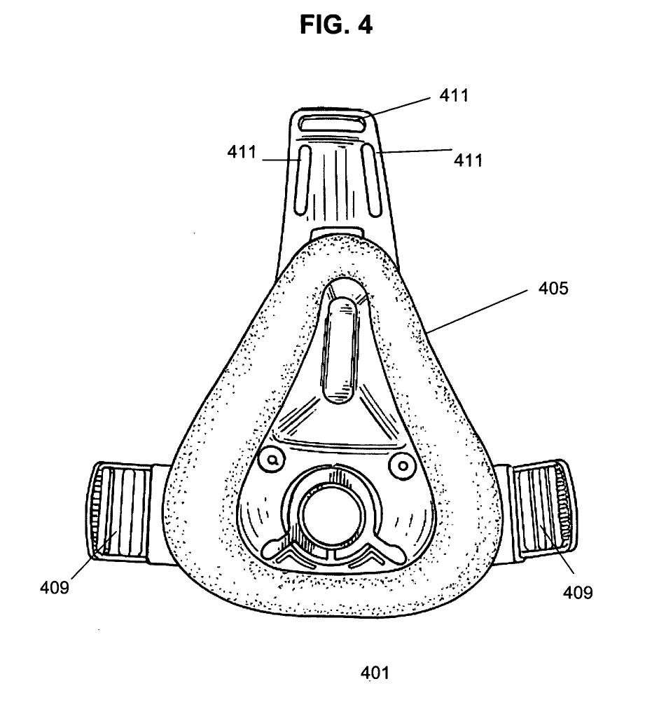

Referring now to FIG. 4, a back view of the CPAP mask 401 according to one embodiment of the present invention is illustrated. The seal used by the present invention according to this embodiment, is preferably a two layer seal, having an inner or first, silicone gel-filled portion 405, and an outer or second, flexible silicone portion with an open, U-shaped cross-section that “balloons” and is gently urged by the positive air pressure to form a seal against user's face, as is known in the art. The silicone gel portion of the seal provides better user comfort and user protection than foam or air-filled cushions.

In a preferred embodiment, this seal is integrated or permanently fixed, such as by adhesive, to the flexible shell portion to eliminate the need for specific seal attachment structure on the shell. This also eliminates the requirement for the user or technician to install/replace the seal mechanism, as well as the requirement for pharmacies to stock replacement seals and their associated components. Additionally, the integrated seal cannot accidentally become detached during routine use/cleaning and does not need to be disassembled to clean interior portions. An integrated seal is allowed by the adjustable nature of the flexible shell (and guide wire) of the present invention that allow a single size shell/seal combination to be used with a wide variety of face sizes and shapes.

The flexible shell of the CPAP full-face mask of the present invention preferably includes a positionable contour wire also referred to as a guide wire (not shown) in the peripheral portion adjacent the seal to allow the periphery of the flexible shell to be positioned so as to conform to the face of individual users. Although this “guide wire” will typically be a metal wire of suitable stiffness that is molded into the periphery of the shell, the term is not meant to be so limiting. As used herein, “positionable guide wire” refers to any structure that can be positioned adjacent or within the periphery of the flexible mask and which can be deformed/positioned to generally conform the periphery of the mask shell to the contours of a user's face. Alternatives to embedded metal wire can include embedded metal strips, surface-mounted metal wires, surface mounted metal strips (i.e., similar to a gasket), embedded or surface mounted structures made up of a plurality of positionable metal or plastic links, and moldable clay or plastic rings.

The flexible nature of the shell used in the CPAP full-face mask of the present invention provides additional comfort to users and those sleeping with users since there is no hard shell to impact or push against a user or bedmate. Although a rigid elbow is still part of the present invention, it is now mounted to a flexible shell so as to be resilient when pushed against objects or persons. Side headgear attachment site 409 are threaded to the attachment of the buckle. Three forehead attachment sites 411 accept head gear to provide for five points of attachement or less depending on the level of secure fit desired by the wearer.

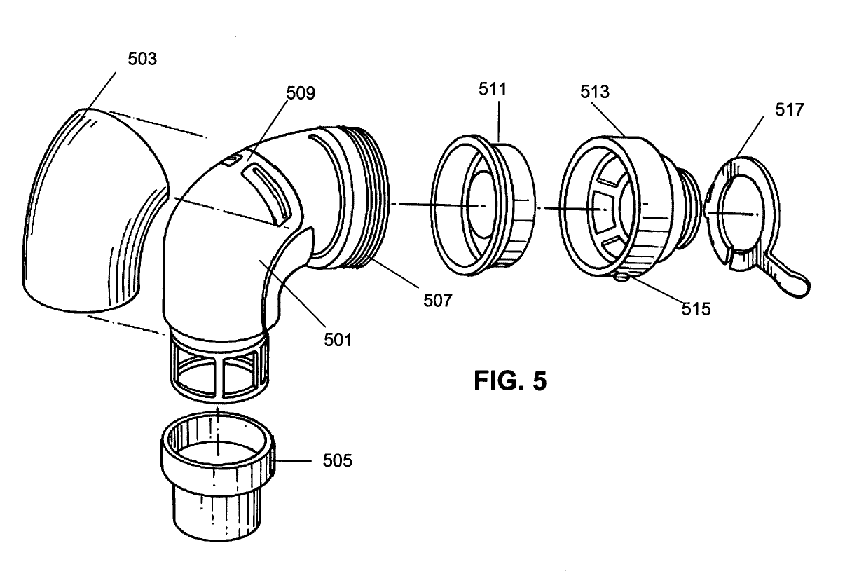

Another aspect of the present invention is illustrated in FIG. 5 wherein an improved elbow is provided. CPAP users often manipulate their mask by grasping the elbow protruding from the front of the mask to use as a handle. A common prior art design, uses a pair of prongs for elbow attachment. These prongs are subject to damage and inadvertent activation when grasped by users to manipulate a mask. Referring now to FIG. 5, prongs are eliminated on the elbow of the present invention. A more reliable elbow assembly is illustrated in wherein a threaded male 507 couples to a female acceptor 513 forming a locking assembly. A membrane 511 is placed within the locking assembly. Alternately, the present invention could also employ a flexible or resilient press-fit (not illustrated) to attach the elbow in order to further reduce the number of parts. Such a press-fit is possible due to the flexible nature of the mask material. Additionally, the present invention provides an exhalation vent 509 and clip-on vent cover 503 on the elbow portion 501 of the assembly 500. Numerous advantages are gained by placing the exhalation vent 509 in this manner. The mask frame (not shown) is cheaper and easier to produce without an exhalation vent. Elbows and exhalation vents typically have a different service life than masks and thus can be replaced independently from the mask of the present invention. Placement of the exhalation vent 509 on the elbow also allows more options regarding the direction of the exhaled air. It can be directed parallel to the mask so as no to directly impinge on bedmates and further diffused or directed away from bedmates by use of a clip-on cover. Although the cover is disclosed with respect to a preferred embodiment, numerous other arrangements are within the skill of one in the art to provide covers, clip-on or otherwise, to diffuse and/or direct exhaled air in a non-objectionable manner. A tab to release and lock the elbow to a frame 515 and a locking clip 517 are also illustrated. Finally, as illustrated in FIG. 5, a swivel 505 provides for a swivel movement of the elbow once attached to a fixed air supply. Flexible tabs engage the interior of the mating swivel element of the air supply tube thereby eliminating the swivel attachment clip of the prior art that can easily be lost or accidentally disengaged. Components illustrated in FIG. 5 are typically formed from a polycarbonate.

As discussed herein, the CPAP full-face mask of the present invention provide many advantages over prior art due to its flexible nature, which allows a single configuration to be used with a wider range of user face sizes and shapes, thereby reducing complexity and costs. The flexible nature of the shell, ergonomic design of components and integrated two layer seal allows greater user comfort, increased ease of use and simplified periodic maintenance/replacement of the mask.

Additionally, for individuals with different shaped faces the present invention can accommodate changes in the face during the life span of the mask without the need to purchase a new mask or seal, as would be necessary when using prior art devices. This is particularly beneficial to individuals undergoing facial surgery to correct deformities, people experiencing changes in weight or for individuals experiencing acute changes in facial structure. One problem for patients with certain conditions that require silicon implants in the cheeks (e.g., to stretch the skin) is that the cheeks are positioned high, therefore prior art masks cannot conform to the face in the same manner as the present invention. It could also be of benefit to those individuals who fluctuate in weight or have facial hair periodically.

Although described herein with respect to a preferred embodiment, the present invention is not meant to be so limited, and other modifications and embodiments that fall within the scope of the present invention will readily apparent to those of skill in the art and is limited only by the claims, attached below.

1. A flexible Continuous Positive Air Pressure (CPAP) full-face mask for conforming to
a wide range of user faces, comprising:
a full-face mask shell, said shell being:
sized to cover a user's nose and mouth,
formed of a flexible, latex-free material, and
including a peripheral portion; and
a seal attached to the peripheral portion of said shell.

2. The CPAP full-face mask of claim 1, further comprising a positionable guide wire adjacent said peripheral portion of said frame to allow said frame and seal to be positioned to generally conform to the contours of a user's face.

3. The CPAP full-face mask of claim 2, further comprising said positionable guide wire being selected from the group consisting of an embedded metal wire, an embedded metal strip, a surface-mounted metal wire, a surface mounted metal strip, an embedded structure made up of a plurality of positionable metal links, a surface mounted structure made up of a plurality of positionable metal links, an embedded structure made up of a plurality of positionable plastic links, a surface mounted structure made up of a plurality of positionable plastic links, a moldable clay ring, and a moldable plastic ring.

4. The CPAP full-face mask of claim 1, wherein said seal is adhesively attached to said shell.

5. The CPAP full-face mask of claim 1, wherein said seal comprises an inner silicone gel cushion and an outer silicone seal that is expandable by positive pressure air of the CPAP full-face mask to seal against a user's face.

6. The CPAP full-face mask of claim 1, further comprising a five-point attachment consisting of a three-point forehead attachment and pair of lower quick release attachments, one on each side of a lower portion of said shell.

7. The CPAP full-face mask of claim 1, further comprising an elbow port in a lower central portion of said shell.

8. The CPAP full-face mask of claim 1, further comprising at least one auxiliary port and port cover, wherein said port cover further includes corners.

9. The CPAP full-face mask of claim 8, wherein said port cover is square.

10. The CPAP full-face mask of claim 1, wherein said shell is formed of flexible silicone.

11. The CPAP full-face mask of claim 7, further comprising a threaded elbow assembly attached to said elbow port.

12. The CPAP full-face mask of claim 11, further comprising an exhalation vent located on said elbow assembly.

13. The CPAP full-face mask of claim 12, further comprising a cover means for said exhalation vent configured to diffuse or direct exhaled air in a non-objectionable manner.

14. The CPAP full-face mask of claim 13, wherein said cover means is a clip-on cover configured to direct exhaled air downward.

15. A method of providing CPAP treatment comprising:
providing a user with the flexible CPAP full-face mask of claim 2, and
substantially conforming the peripheral portion of said shell and seal to the contours of said user's face by appropriately positioning said positionable guide wire.

16. A method of fitting a CPAP full-face mask to a patients face, comprising:
positioning a deformable mask adjacent a patients face; and
deforming a peripheral portion of said deformable mask to substantially match contours of said face.
